(19) United States
(12) Patent Application Publication
(10) Pub. No.: US 2026/0000018 A1
(43) Pub. Date: Jan. 1, 2026

(54) String trimmer attachments and related methods of use

(71) Applicant: Patrick Bryan Huval, JR., Austin, TX (US)

(72) Inventor: Patrick Bryan Huval, JR., Austin, TX (US)

(21) Appl. No.: 18/757,743

(22) Filed: Jun. 28, 2024

(51) Int. Cl. A01D 34/84; A01D 34/416; A01D 101/00

(52) U.S. Cl. CPC A01D 34/84; A01D 34/416; A01D 2101/00

(57) ABSTRACT

Disclosed is A string trimmer attachment is disclosed that enables users to create professional-quality edges effortlessly. The attachment comprises an attachment means (1100) for securing it to the shaft (2000) of a string trimmer, such as a double bolt pipe clamp. A multi-directional joint (1200), like a lockable ball and socket joint, is coupled to the attachment means, allowing for angle adjustment of the trimmer head. An adjustable leg (1300), such as a telescoping aluminum arm, connects to the joint for setting the desired height. A guiding means (1400), e.g., a wheel and axle, is attached to the leg's end to guide the trimmer head's movement along the edge. The attachment seamlessly integrates with existing trimmers, providing a versatile and user-friendly solution for achieving professional-grade edging results.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is in the field of edgers and trimmer.

### Background of the Invention

The subject matter of this disclosure relates to a string trimmer attachment designed to help layperson users effortlessly create professional-quality edges. The subject matter addresses the familiar challenges faced by homeowners or lawn care workers when using traditional string trimmers to maintain clean, straight edges of a grass yards or flower garden. Traditionally, achieving consistent and even edges with a string trimmer has been a labor-intensive and physically demanding task. Maintaining a steady trimmer head at the correct angle and distance from the edge requires significant effort, often leading to arm and back fatigue. Furthermore, inconsistent distances from surfaces result in excessive string usage and uneven edges, compromising the overall appearance of the lawn or garden. In view of these issues presented, the subject matter disclosed presents a solution that seamlessly integrates with existing string trimmers, providing an adjustable and user-friendly attachment for effortless edging.

### RELATED ART

U.S. Pat. No. 4,894,916 by Nimz et al. discloses an adjustable wheel stabilizer.

U.S. Pat. No. 4,981,012 by Claborn discloses an apparatus for converting a gas-powered flexible line trimer for use as a lawn edger.

U.S. Pat. No. 6,745,549 by Taylor discloses a wheeled attachment for grass trimmer.

U.S. Pub. App. No. 2005/0098328 by Popp discloses a trimmer attachment.

### SUMMARY OF THE INVENTION

In view of the foregoing, an object of this specification is to disclose a string trimmer attachment designed to create professional-quality edges. A few key components of the disclosed trimmer include:
a clamp with a ball joint that attaches to the string trimmer shaft, allowing for angle adjustment;
a telescoping aluminum arm connected to the ball joint, enabling height adjustment; and/or
a wheel attached to the end of the telescoping arm that rolls along the edge, guiding the trimmer for straight, clean edges.

Some of the problems solved by this trimmer include the tendency of prior art trimmers to produce inconsistent edges when operated by laypersons, arm fatigue of the user, and excessive string waste as compared to using a traditional string trimmer for edging without the attachment.

### BRIEF DESCRIPTION OF THE SEVERAL VIEWS OF THE DRAWINGS

Other objectives of the disclosure will become apparent to those skilled in the art once the invention has been shown and described. The way these objectives and other desirable characteristics can be obtained is explained in the following description and attached figures in which:

FIG. 1 is a perspective view of a string trimmer attachment;

FIG. 2 is a perspective view of a clamp with lockable, multi-directional joint;

FIG. 3 is a perspective view of the string trimmer attachment coupled to the shaft 2000 of a conventional string trimmer (not shown); and,

FIG. 4 is an illustrative view of the string trimmer attachment.

It is to be noted, however, that the appended figures illustrate only typical embodiments of this invention and are therefore not to be considered limiting of its scope, for the invention may admit to other equally effective embodiments that will be appreciated by those skilled in the relevant arts. Also, figures are not necessarily made to scale but are representative.

### DETAILED DESCRIPTION OF PREFERRED EMBODIMENTS

Disclosed is a preferred embodiment of a string trimmer attachment. Suitably, this embodiment of the string trimmer attachment is designed to help novice yard-workers or landscapers create professional-quality edges. This preferred embodiment is disclosed in greater detail in connection with the figures.

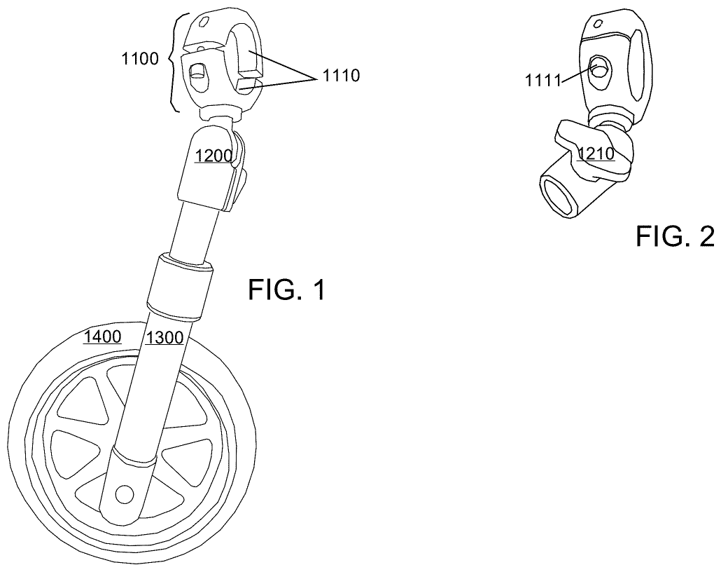

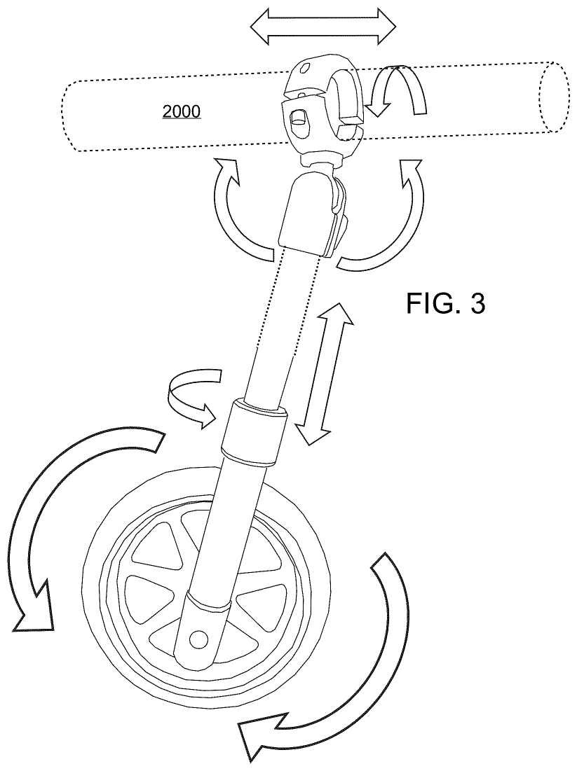

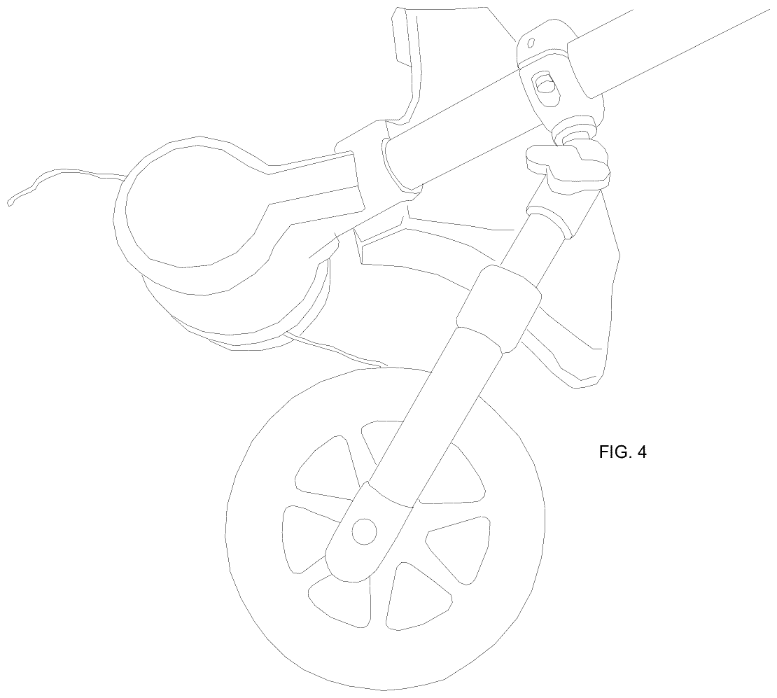

FIG. 1 is a perspective view of a preferred embodiment of a string trimmer attachment 1000. FIG. 3 is a perspective view of the embodiment 100 on a shaft 200 of a trimmer. As shown, the string trimmer attachment 1000 has at least four components, among others, that work together to provide an adjustable and user-friendly solution for creating professional-quality edges effortlessly. First, the disclosed apparatus features an attachment means 1100 for attaching the apparatus 1000 to a shaft 2000 of a typical string trimmer (not shown in FIG. 1 or 2) between the trimmer's head (not shown in FIG. 1 or 2) and handholds (not shown in FIG. 1 or 2). Second, the preferred embodiment has a multi-directional joint 1200 coupled to the attachment means 1100. Third, the preferred embodiment of the attachment 1000 has an adjustable leg 1300 coupled to the multi-directional joint 1200 for setting a level of the trimmer's head (not shown in FIG. 1 or 2). Finally, the disclosed embodiment has a guiding-means for leading or directing a movement of the string trimmer's head (not shown in FIG. 1 or 2). These components are addressed one-by-one below.

FIGS. 1 through 3 illustrate an attachment means 1100. In one embodiment, the apparatus connects to the round shaft 2000 of a standard string trimmer via a clamp mechanism. Suitably, the clamp mechanism may be any known pipe or hose clamp. As shown in the preferred embodiment, a double bolt pipe clamp 1100 is employed. The particular clamp includes two, c-shaped parts 1110 that enclose the shaft 2000 of a trimmer (not shown in FIGS. 1 and 2) and are secured via bolts 1111 to create a friction-enhanced interface to generally restrict rotation of the clamp 1100 around the shaft of the trimmer (not shown in FIGS. 1 and 2). Suitably, the clamp 1100 may be rotatably adjusted around the shaft of the trimmer (not shown in FIGS. 1 and 2) via loosening the bolts to release the friction-enhanced interface. In some embodiments, the c-shaped parts 1110 could include a friction enhanced material (e.g., rubber) layer or coating on the inside surface. In operation, the clamp 1100 should be designed to securely grip the trimmer shaft while enabling smooth rotation when needed, ensuring the attachment can be positioned at a desirable angle relative to the trimmer head. In other modes of operation, the clamp may be loosened or unlocked so that the attachment can swivel with respect to the shaft during use. Suitably, in some embodiments, a spring or elastic member may be employed so that a loose clamp may be returned to an initially set position. It should be further noted that the clamp mechanism is designed to fit multiple shaft sizes, accommodating variations in tubing from different manufacturers. This ensures compatibility with a wide range of string trimmer models, enhancing the attachment's versatility. Additionally, the attachment may be easily attached and removed, such that the string trimmer is useful for other purposes outside of edging. Preferably, such quick-release feature provides users with the flexibility to switch between different trimming tasks without hassle.

It is noteworthy that, in other embodiments other types of pipe clamps could be employed instead of the particular clamp 1100 identified in the preferred embodiment. Such alternative clamps could include, for example: Standard or Split Band Pipe Clamps; U-Bolt Clamps; Saddle Clamps; Heavy Duty Pipe Clamps; Anchor Point Pipe Clamps; Pipe Clamps for Sprinkler Systems; Pipe Clamps for Spiral-Seam Pipes; High Temperature Pipe Clamps. Hose clamps are also an option for the clamping mechanism or the attachment means, including: Hose Clamps; Worm-Drive Hose Clamps; Ear Clamps (Oetiker Clamps); Single-Wire Hose Clamps; Double-Wire Hose Clamps; Screw Hose Clamps; Spring Hose Clamps; Wire Hose Clamps; Plastic Hose Clamps; Hose Clamps with Linings (Rubber/Plastic); or Pinch Clamps. Those of skill in the art will know well the types of clamps or attachment mechanisms that can be used to secure the device to the shaft or body of a string trimmer.

FIGS. 1 through 3 illustrate a multi-directional joint 1200 attached to the mounting means 1100. As shown, the double bolt clamp 1100 features a lockable ball and socket joint 1200 (sometimes called a ball joint) that allows for multi-directional pivoting and angle adjustment of the attachment 1000 relative to the shaft of the trimmer. This adjustability is ideal for accommodating different edging surfaces and user preferences. Suitably, the lock can be unlocked or locked via a knob 1210 that constricts or loosens the interface of the ball and socket. As with the clamp, the ball and socket interface may be outfitted with friction enhancing materials or coatings. If locked, the attachment 1000 may maintain a constant angle relative to the shaft. If unlocked or loosened, the ball joint 1200 is a component that enables the attachment to pivot and adjust during use, ensuring the wheel remains in consistent contact with the ground at all times. This feature is essential for achieving clean, straight edges without the need for excessive effort or string usage and the need. The ball joint's smooth rotation and locking mechanism allow the user to either precisely set the desired angle, maintaining the optimal position throughout the edging process or allow continual adjustments on the fly e.g. due to the surface or edge on or along which the apparatus is operating. Suitably, in some embodiments, a spring or elastic member may be employed so that a loose multi-positional joint may be returned to an initially set position.

Although the preferred embodiment is depicted with a ball and socket joint 1200, other joints may suffice for purpose of the attachment 1000. For instance, a condyloid joint or a heim joint could be used instead of a ball & socket joint in an alternative embodiment. Other potential alternatives to a traditional ball and socket joint also exist, including Rubber/Elastomeric Joints; Flexible Couplings/U-Joints; Plastic/Polymer Ball Joints.

FIGS. 1 and 3 illustrate a telescoping arm. As shown, attached to the ball joint 1200 is an telescoping arm 1300. This arm 1300 is suitably adjustable in length, allowing the user to set the apparatus 1000 at the appropriate height for their comfort and the specific type of edge being created. The telescoping mechanism 1300 provides a range of height adjustments, accommodating different user heights, edging surfaces, and trimmer models. The in one embodiment, the arm 1300 is aluminum and this construction ensures the arm is lightweight yet rigid, providing stability and durability during operation. Suitably, the arm may be locked in an extended or shortened state at the appropriate level for use. Alternatively, the arm may be unlocked or loosened allowing for height or level adjustments on the fly during use or to adjust to a sudden change in edge or work requirements. Suitably, in some embodiments, a spring or elastic member may be employed so that a loose telescoping member may be returned to an initially set position. A loose telescoping arm with a spring offers the functionality of tapping the trimmer's head on the ground during use such that additional string may be dispensed for trimming as the string breaks.

Although the preferred embodiment features a telescoping arm, other adjustment mechanism could alternatively function to adjust the level of the trimmer head (not shown) level. For instance, an accordion or scissor arm may be used. Other embodiments could feature the following forms of adjustment mechanism: linear slides, scissor lifts, elevators, rack and pinion adjustments, or cable and pully systems.

FIGS. And 3 illustrate a wheel and axle attachment 1400. Suitably, the wheel and axle attachment 1400 are located at the distal end of the telescoping arm 1300. Suitably the wheel 1400 is attached, serving as the guiding component for the head of a string trimmer. In a preferred embodiment, the wheel 1400 is designed to roll smoothly along a track adjacent to the edge of the lawn, driveway, or garden bed, ensuring a straight and consistent edge is cut by the string of the stringed trimmer. The wheel may be attached using a 3-inch bolt axle with a half-inch spacer between the wheel and the telescoping arm 1300. This spacer allows the wheel to rotate freely and smoothly, minimizing friction and ensuring optimal performance. Although a wheel 1400 and axle are employed in the preferred embodiment, other alternatives to a wheel, like a slider, a caster or sled, might be employed. Suitably, alternative embodiments of the attachment might feature a mechanism that maintains the wheel at a constant distance from the edge, further improving the consistency and quality of the edging results. In such embodiments, said enhancement could suitably ensure that the trimmer head remains at an optimal distance from the edge, regardless of variations in terrain.

The combination of these four components creates a versatile and user-friendly attachment that seamlessly integrates with existing string trimmers. The adjustable design accommodates different user preferences, edging surfaces, and trimmer models, while the wheel guidance system ensures professional-quality results with minimal effort and string usage. As noted above, one or all of the various components may be loose or locked in a position. Each arrangement of locked or loosened components achieves a unique operation for edging a yard or area via a string trimmer.

When all of the components are locked in position except the wheel's rotation, a method to achieve pristine, manicured edges with minimal exertion, follow these meticulous steps when the attachment means, joint, and adjustable leg are securely locked into position:

### 1. Preparation

a. Ensure the double bolt pipe clamp (1100) is tightly fastened around the trimmer shaft (2000), restricting any rotational movement.
b. Lock the multi-directional ball and socket joint (1200) by tightening the knob (1210), fixing the desired angle between the attachment and trimmer shaft.
c. Extend or retract the telescoping aluminum arm (1300) to your preferred height, then lock it in place, establishing the optimal trimmer head level.

### 2. Operation

a. Grasp the trimmer's handles firmly, adopting a comfortable stance alongside the edge you wish to define.
b. Gently lower the apparatus until the wheel (1400) meets the ground, its axle parallel to the boundary you aim to sculpt.
c. Engage the trimmer's motor, allowing the string to whirl into a precise, high-velocity orbit.
d. Maintaining a steady pace, guide the trimmer forward, permitting the wheel (1400) to trace the edge with unwavering precision.
e. The wheel's smooth rotation will effortlessly direct the trimmer head, ensuring a crisp, uniform edge with each pass.

By harnessing the attachment's locked and calibrated components, you can channel your trimmer's power into creating immaculate borders with minimal physical strain, transforming your outdoor spaces into a showcase of horticultural artistry.

When all of the components are loose in position except the wheel's rotation, a method to harness the full versatility of this ingenious attachment, allowing it to seamlessly adapt to diverse edging surfaces and contours, follow these intricate steps when the attachment means, joint, and adjustable leg are purposefully left unfastened:

### 1. Preparation

a. Loosen the double bolt pipe clamp (1100) around the trimmer shaft (2000), permitting rotational freedom.
b. Unlock the multi-directional ball and socket joint (1200) by loosening the knob (1210), enabling fluid pivoting between the attachment and trimmer shaft.
c. Extend or retract the telescoping aluminum arm (1300) to your desired length, leaving it unlocked for on-the-fly adjustments.

### 2. Operation

a. Grasp the trimmer's handles firmly, adopting a comfortable stance alongside the edge you wish to sculpt.
b. Gently lower the apparatus until the wheel (1400) meets the ground, allowing the joint (1200) to pivot and maintain consistent wheel-to-ground contact.
c. Engage the trimmer's motor, setting the string into a precise, high-velocity orbit.
d. Maintaining a steady pace, guide the trimmer forward, permitting the wheel (1400) to trace the edge's contours fluidly.
e. As the terrain or edge shifts, the unlocked components will dynamically adjust:
   The joint (1200) will pivot, ensuring the wheel remains flush against the boundary.
   The telescoping arm (1300) will extend or retract, accommodating changes in height or depth.
   The clamp (1100) will rotate around the shaft, aligning the trimmer head optimally.

By harnessing the attachment's unlocked, free-flowing components, you can effortlessly navigate intricate edges and undulating surfaces, channeling your trimmer's power into creating immaculate, professional-grade borders tailored to the unique landscape.

Although the method and apparatus is described above in terms of various exemplary embodiments and implementations, it should be understood that the various features, aspects, and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus, the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more,” or the like; and adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to,” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts, and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. A string trimmer attachment comprising:
an attachment means (1100) for securing it to the trimmer shaft (2000) between a trimmer head and a trimmer handhold,
a multi-directional joint (1200) coupled to the attachment means for angle adjustment of an adjustable telescoping leg (1300) relative to the shaft (2000),
the adjustable extension means (1300) connected to the joint for setting a distance between the shaft (2000) and a guiding means (1400), and
a guiding means (1400) attached to an end of the adjustable extension means (1300) to guide trimmer head movement along an edge of a lawn for creating professional-quality, straight edges effortlessly.

2. The string trimmer attachment of claim 1 wherein the attachment means (1100) is a double bolt clamp.

3. The string trimmer attachment of claim 1 wherein the attachment means (1100) is selected from the group consisting essentially of a standard or split band pipe clamp, a u-bolt clamp, a saddle clamp, a pipe clamp, a anchor point pipe clamp, and a hose clamp.

4. The string trimmer attachment of claim 2 wherein the multi-directional joint (1200) is a ball and socket joint.

5. The string trimmer of claim 2 wherein the multi-directional joint (1200) is selected from the group consisting essentially of condyloid joint, heim joint, rubber or elastomeric joint, u-joint, ball joint, swivel joint, and pivot joint.

6. The string trimmer of claim 3 wherein the multi-directional joint (1200) is selected from the group consisting essentially of condyloid joint, heim joint, rubber or elastomeric joint, u-joint, ball joint, swivel joint, and pivot joint.

7. The string trimmer of claim 2 where the adjustable extension means (1300) is a telescoping arm.

8. The string trimmer of claim 4 where the adjustable extension means (1300) is a telescoping arm.

9. The string trimmer of claim 2 where the adjustable extension means (1300) is a selected from the group consisting essentially of accordion arm, scissor arm, linear slide mechanism, scissor lift mechanism, rack and pinion adjustment system, and cable and pulley system.

10. The string trimmer of claim 4 where the adjustable extension means (1300) is a selected from the group consisting essentially of accordion arm, scissor arm, linear slide mechanism, scissor lift mechanism, rack and pinion adjustment system, and cable and pulley system.

11. The string trimmer of claim 2 where the guiding means (1400) is a wheel.

12. The string trimmer of claim 4 where the guiding means (1400) is a wheel

13. The string trimmer of claim 7 where the guiding means (1400) is a wheel.

14. The string trimmer of claim 2 where the guiding means (1400) is selected from the group consisting essentially of a slider, caster, and sled.

15. The string trimmer of claim 4 where the guiding means (1400) is selected from the group consisting essentially of a slider, caster, and sled.

16. The string trimmer of claim 7 where the guiding means (1400) is selected from the group consisting essentially of a slider, caster, and sled.

17. A method of using a string trimmer attachment, the method comprising:
a. securing an attachment means to a trimmer shaft, wherein the attachment means is adaptable to fit multiple shaft sizes;
b. adjusting a multi-directional joint coupled to the attachment means to set a desired angle between the trimmer shaft and an adjustable telescoping leg;
c. extending or retracting the adjustable telescoping leg connected to the multi-directional joint to set a distance between the trimmer shaft and a guiding wheel attached to an end of the leg;
d. positioning the guiding wheel against an edge to be trimmed;
e. operating the string trimmer while allowing the guiding wheel to roll along the edge, thereby guiding the trimmer head's movement and maintaining a constant distance from the edge;
f. adjusting the angle of the multi-directional joint and/or the length of the telescoping leg as needed to accommodate changes in terrain or edge profile;
g. completing the trimming operation; and
h. easily removing the attachment from the trimmer shaft when finished or when the trimmer is needed for other purposes.

18. A method of using a string trimmer attachment, wherein all components are loose in position except the wheel's rotation, the method comprising:
a. loosening an attachment means around a trimmer shaft, permitting rotational freedom of the attachment means;
b. unlocking a multi-directional joint coupled to the attachment means, enabling fluid pivoting between the attachment and the trimmer shaft;
c. extending or retracting an adjustable extension mechanism connected to the joint to a desired length, leaving it unlocked for on-the-fly adjustments;
d. grasping the trimmer's handles firmly and adopting a comfortable stance alongside the edge to be sculpted;
e. lowering the apparatus until the guiding wheel meets the ground, allowing the joint to pivot and maintain consistent wheel-to-ground contact;
f. engaging the trimmer's motor to set the string into a high-velocity orbit;
g. guiding the trimmer forward at a steady pace, permitting the wheel to trace the edge's contours fluidly;
h. allowing the unlocked components to dynamically adjust to changes in terrain or edge profile, wherein:
i. the joint pivots to ensure the wheel remains flush against the boundary;
ii. the adjustable extension means extends or retracts to accommodate changes in height or depth;
iii. the attachment means rotates around the shaft to align the trimmer head optimally.

19. The method of claim 18 wherein the attachment means is a double bolt clamp.

20. The string trimmer of claim 2 where the adjustable extension means is a telescoping arm.
